(19) United States
(12) Patent Application Publication
(10) Pub. No.: US 2009/0223798 A1
(43) Pub. Date: Sep. 10, 2009

(54) SLIDE OPERATION TYPE ELECTRICAL COMPONENT

(76) Inventors: Toshitaka Miwa, Miyagi-ken (JP); Kazuya Yorino, Miyagi-ken (JP); Makoto Sasaki, Miyagi-ken (JP); Yoshiteru Takayanagi, Miyagi-ken (JP)

Correspondence Address: BRINKS HOFER GILSON & LIONE, P.O. BOX 10395, CHICAGO, IL, 60610, US

(21) Appl. No.: 12/398,421

(22) Filed: Mar. 5, 2009

(30) Foreign Application Priority Data
Mar. 10, 2008 (JP) 2008-059849

(51) Int. Cl. H01H 25/00

(52) U.S. Cl. 200/5 R

(57) ABSTRACT

A slide operation type electrical component includes a slider that includes protruding parts extending in predetermined directions, a holding case that includes guide surfaces slidable on the protruding parts and holds the slider so as to allow the slider to be slidable, and an electrical element that is engaged with the slider and driven when sliding. The slide operation type electrical component includes a notch that is opened at a protruding end surface of at a part of the protruding parts, guideways that are formed at the holding case in the shape of a hole or groove extending in the sliding direction of the slider so that side walls of the guideways form the guide surfaces, and elastic pushing means that is disposed at a part of the guideways so as to elastically come in contact with an internal surface of the notch.

### CROSS REFERENCE TO RELATED APPLICATION

The present invention contains subject matter related to and claims priority to Japanese Patent Application No. 2008-059849 filed in the Japanese Patent Office on Mar. 10, 2008, the entire contents of which being incorporated herein by reference.

### BACKGROUND

1. Technical Field

The present invention relates to a slide operation type electrical component that is suitable for use in a vehicle power seat switch.

2. Related Art

A vehicle power seat switch is a slide operation type electrical component that adjusts the positions of the seat portion and the backrest portion of a vehicle seat by using a drive motor. A main body, which is provided near the seat portion, is provided with a plurality of sliders, a holding case that holds the respective sliders so as to allow the sliders to be slidable in predetermined directions, and a plurality of switch elements that is individually driven in the respective sliders. The sliders are selectively slid by the operating knobs mounted on the main body, and the contact of the corresponding switch element is switched by the slid slider.

In the past, as this kind of slide operation type electrical component, there is known a component that generates a click feeling by the corresponding switch element and performs a contact switching operation when the slider is slid by a switch element in which a click mechanism is built (for example, see Japanese Registered Utility Model No. 2532874). Accordingly, an operator can perceive that the slider is reliably slid, through a click feeling transmitted to fingers.

In addition, a slide operation type electrical component, which generates click feeling at a position different from the position of a switch element when a slider is slid, that is not a vehicle power seat switch has been known (for example, see Japanese Unexamined Patent Application Publication No. 5-217464). In this slide operation type electrical component, a click groove is formed on one surface (surface facing a slider) of one wall of a holding case that holds a slider so as to allow the slider to be slidable, a coil spring and a steel ball are assembled with the slider, and the steel ball elastically comes in contact with one surface of the wall of the holding case by a pushing force of the coil spring. Accordingly, if the slider is slid, the steel ball is engaged or disengaged with or from the click groove of the holding case, so that a click feeling is generated.

However, as in the related art disclosed in Japanese Registered Utility Model No. 2532874, in the case wherein the slide operation type electrical component that generates a click feeling by using the click mechanism built in the switch element, a click feeling generated during a sliding operation is determined by the click mechanism of the switch element. Therefore, it is difficult to set desired click feeling. As a result, it is difficult to obtain good operational feeling. In contrast, like in the related art disclosed in Japanese Unexamined Patent Application Publication No. 5-217464, in the case wherein the slide operation type electrical component that generates a click feeling by making the steel ball be engaged or disengaged with or from the click groove formed on the wall of the holding case, it is possible to set desired click feeling by appropriately selecting the depth or shape of the click groove. However, even though the steel ball always elastically comes in contact with the wall of the holding case that includes a click groove on one surface thereof, the mechanical strength of the wall of the holding case should be increased to avoid problems. Therefore, it is difficult not to increase the size of the holding case due to the increase in the thickness of the wall, or it is difficult to make the click groove deep due to the limitation on depth. As a result, there has been a problem that it is difficult to obtain a clear click feeling.

### SUMMARY

An illuminated switch includes a slider that includes protruding parts extending in predetermined directions, a holding case that includes guide surfaces slidable on the protruding parts and holds the slider so as to allow the slider to be slidable, and an electrical element that is engaged with the slider and driven when sliding. The slide operation type electrical component includes a notch that is opened at a protruding end surface of a part of the protruding parts, guideways that are formed at the holding case in the shape of a hole or groove extending in the sliding direction of the slider so that side walls of the guideways form the guide surfaces, and elastic pushing means that is disposed at a part of the guideways so as to elastically come in contact with an internal surface of the notch.

In the slide operation type electrical component, a part or whole of the notch formed at the protruding parts of the slider may form click grooves where the elastic pushing means disposed at the guideways of the holding case can be engaged or disengaged. Further, a sliding surface with which the elastic pushing means elastically comes in contact is formed at the protruding part functioning as a guide of the slider. Accordingly, it is possible to easily increase the mechanical strength of a portion of the slider to which a strong load is applied. Further, even though the notch opened at the protruding end surface of the protruding part is formed to be relatively large, the notch hardly affects the mechanical strength of the slider. Therefore, even though the size of the slider or the holding case is not particularly increased, the limitation on the depth or shape of the click groove is decreased, so that it is easy to set desired click feeling.

### BRIEF DESCRIPTION OF THE DRAWINGS

FIG. 1 is a view showing the appearance of a slide operation type electrical component according to an embodiment of the invention.

FIG. 2 is a plan view of a holding case that is included in the slide operation type electrical component.

FIG. 3 is a rear view of the holding case.

FIG. 4 is a plan view of main portions of one slider that is held in the holding case.

FIG. 5 is a cross-sectional view taken along a line A-A of FIG. 4.

FIG. 6 is a cross-sectional view taken along a line B-B of FIG. 4.

FIG. 7 is a cross-sectional view of main portions when the slider shown in FIG. 6 has been slid.

FIG. 8 is a cross-sectional view of main portions when a switch element and the slider corresponding to FIG. 7 are engaged with each other.

FIG. 9 is a plan view of main portions when the slider is omitted from FIG. 8.

FIG. 10 is a side view of the slider that is included in the slide operation type electrical component.

FIG. 11 is a rear view of the slider.

FIG. 12 is a perspective view of main portions when a guideway and a spring receiving portion of the slide operation type electrical component are seen from the rear side.

### DESCRIPTION OF EXEMPLARY EMBODIMENTS

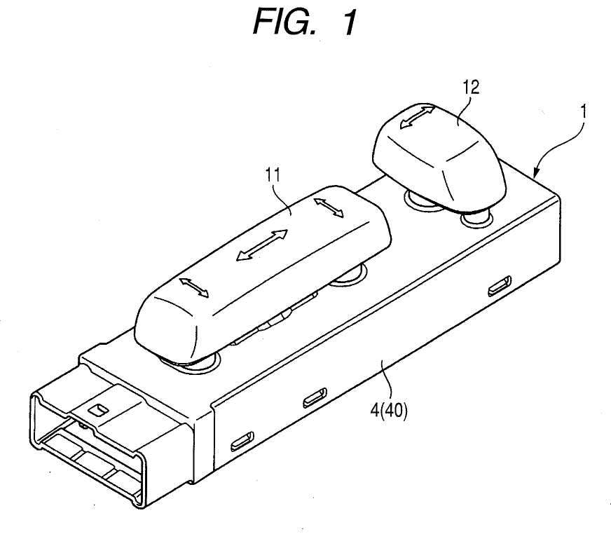

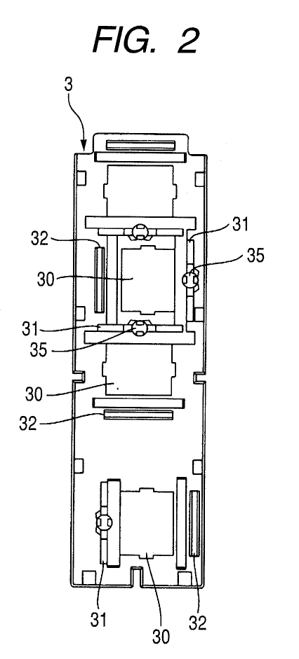

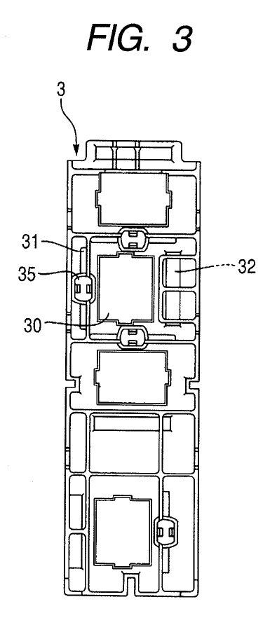

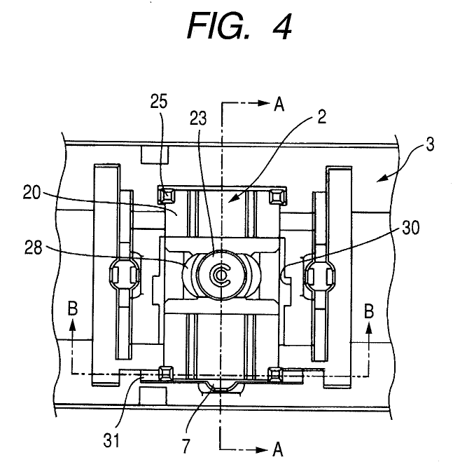

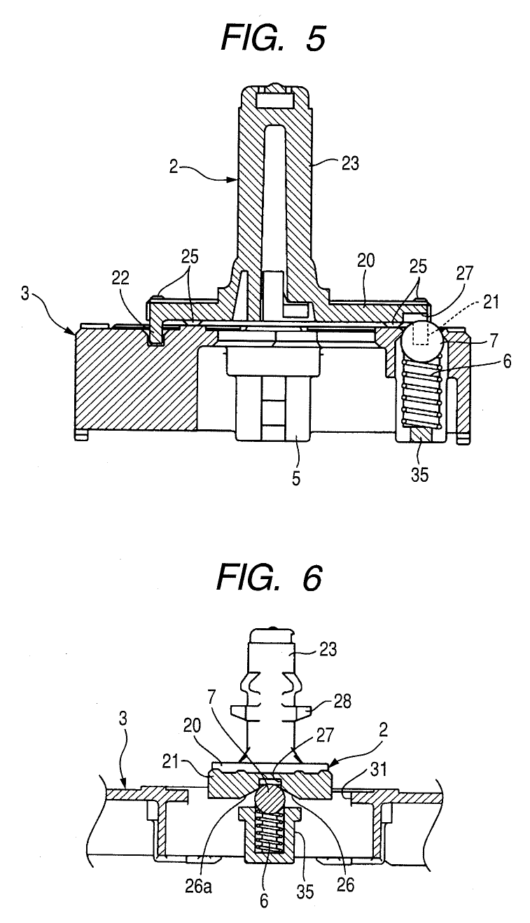

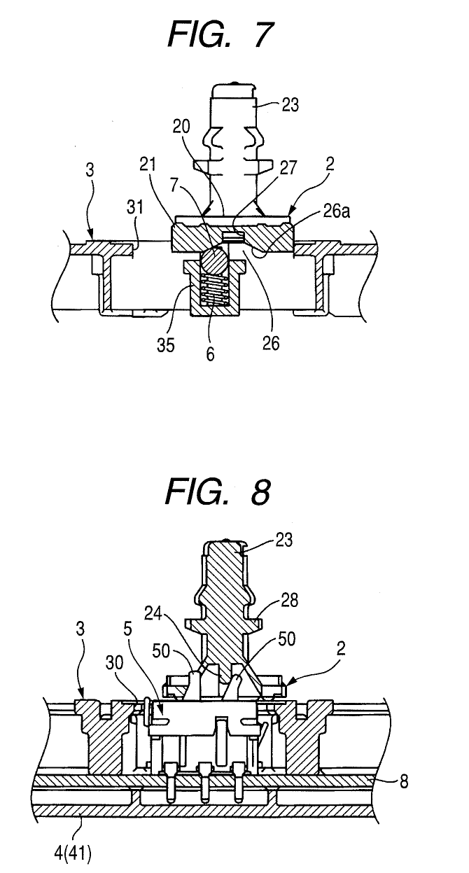

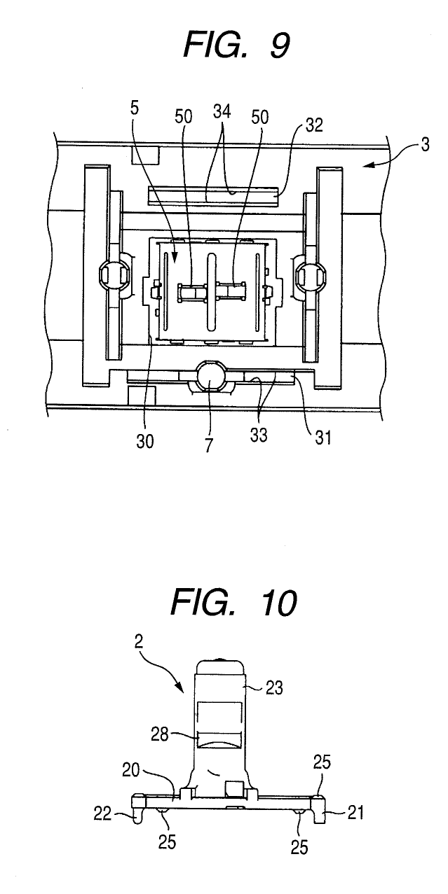

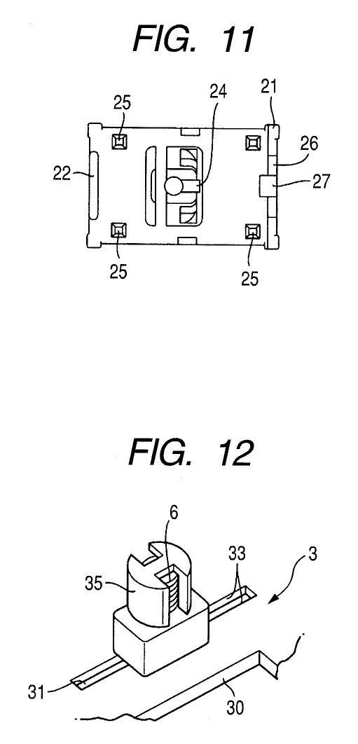

An embodiment of the invention will be described below with reference to drawings. FIG. 1 is a view showing the appearance of a slide operation type electrical component according to an embodiment of the invention. FIG. 2 is a plan view of a holding case that is included in the slide operation type electrical component. FIG. 3 is a rear view of the holding case. FIG. 4 is a plan view of main portions of one slider that is held in the holding case. FIG. 5 is a cross-sectional view taken along a line A-A of FIG. 4. FIG. 6 is a cross-sectional view taken along a line B-B of FIG. 4. FIG. 7 is a cross-sectional view of main portions when the slider shown in FIG. 6 has slid. FIG. 8 is a cross-sectional view of main portions when a switch element and the slider corresponding to FIG. 7 are engaged with each other. FIG. 9 is a plan view of main portions when the slider is omitted from FIG. 8. FIG. 10 is a side view of the slider that is included in the slide operation type electrical component. FIG. 11 is a rear view of the slider. FIG. 12 is a perspective view of main portions when a guideway and a spring receiving portion of the slide operation type electrical component are seen from the rear side.

A slide operation type electrical component according to this embodiment is used as a vehicle power seat switch. As shown in FIG. 1, the slide operation type electrical component mainly includes a main body 1 that is provided near a seat portion of a vehicle seat, and operating knobs 11 and 12 that are mounted on the main body 1. The main body 1 is provided with four sliders 2, a holding case 3 that holds the respective sliders 2 so as to allow the sliders to be slidable in predetermined directions, a case 4 that is an outer shell case in which members including the holding case 3 are received, and four switch elements 5 that are mounted on a printed circuit board 8 provided on the rear side of the holding case 3 and individually driven in the respective sliders 2. Further, a predetermined slider 2 is selectively slid by the operating knob 11 or 12, and the contact of the corresponding switch element 5 is switched by the slid slider 2. The case 4 is formed of an upper case 40 (see FIG. 1) and a cover 41 (see FIG. 8) that are integrated with each other by snap. Further, since the shapes, support structures, and operation of the sliders 2 are basically the same as each other, those of only one slider 2 will be mainly described in this embodiment.

As shown in FIGS. 4 to 6 or FIGS. 10 and 11, the slider 2 is provided with a rectangular pedestal part 20, first and second protruding parts 21 and 22 that are parallel to each other and protrude downward from both ends of the pedestal part 20, a protruding shaft part 23 that is erected from the central portion of the pedestal part 20, a driving protrusion 24 that protrudes downward from the central portion of the rear surface of the pedestal part 20, and a plurality of restricting protrusions 25 that protrudes from four corners of the upper surface of the pedestal part 20 and protrudes from portions near the four corners of the rear surface by a predetermined height. The first and second protruding parts 21 and 22 extend in a lateral direction of the pedestal part 20. The first protruding part 21 is a part that is inserted into a first guideway 31 of the holding case 3 and guided. A notch 26, which is opened at the protruding end surface (bottom) of the first protruding part, is formed at the first protruding part 21. The shape of the notch 26 is tapered toward the inside from the opened end, and a click groove 27 is formed at the innermost portion of the notch 26. Further, as shown in FIGS. 5 to 7, a steel ball 7, which is a drive body, slidably and elastically comes in contact with an internal surface 26a of the notch 26. When the slider 2 is not operated, the steel ball 7 is engaged with the click groove 27. However, when the slider 2 is slid, the steel ball 7 is separated from the click groove 27, so that click feeling is generated. The second protruding part 22 is a part that is inserted into a second guideway 32 of the holding case 3 and guided.

Further, a pair of engagement arms 28, which is to be snapped with the operating knob 11, protrudes from the protruding shaft part 23 of the slider 2 in a lateral direction. If the operating knob 11 is operated and moved in the lateral direction of the pedestal part 20, the slider 2 is driven and slides in the same direction as described above. Meanwhile, the operating knob 12 is snapped with the protruding shaft part 23 of one of four sliders 2. However, the operating knob 11 or 12 is mounted so as to drive each of the sliders 2 in one direction. Even though the operating knob 11 (12) is moved in a longitudinal direction of the pedestal part 20 of a predetermined slider 2, the slider 2 is not operated. The plurality of restricting protrusions 25 is used to restrict the position of the slider 2 in a height direction. The restricting protrusions 25 formed on the upper surface of the pedestal part 20 can slide on the ceiling surface of the case 4 (upper case 40), and the restricting protrusions 25 formed on the rear surface of the pedestal part 20 can slide on the upper surface of the holding case 3. Since these restricting protrusions 25 are provided in balance, the sliders 2 are hardly inclined or jounce when sliding.

As shown in FIGS. 2 and 3, the holding case 3 includes rectangular central openings 30 that are formed at four positions corresponding to the sliders 2, and first and second guideways 31 and 32 that extend parallel to each other with the central openings 30 therebetween. As shown in FIG. 8, a pair of actuators 50 of the switch element 5 passes through the central opening 30, and the driving protrusion 24 of the slider 2 is positioned between the actuators 50. The first and second guideways 31 and 32 extend along a long side of the central opening 30, that is, in a sliding direction of the slider 2. The first guideway 31 is formed in the shape of a hole, and the second guideway 32 is formed in the shape of a groove. The side walls of the first guideway 31 are formed of guide surfaces 33 on which the side surfaces of the first protruding part 21 of the slider 2 can slide, and the side walls of the second guideway 32 are formed of guide surfaces 34 on which the side surfaces of the second protruding part 22 of the slider 2 can slide. The protruding end surface (bottom) of the first protruding part 21 inserted into the first guideway 31, which is formed in the shape of a hole, is not in contact with the holding case 3. Further, the protruding end surface of the second protruding part 22 inserted into the second guideway 32, which is formed in the shape of a groove, is not in contact with the holding case 3 (see FIG. 5).

Furthermore, a spring receiving portion 35, which faces the first guideway 31, is formed at the holding case 3 so as to be connected to the guide surface 33. As shown in FIGS. 5 and 6 or FIG. 12, a coil spring 6 is received in the spring receiving portion 35, and a steel ball 7 elastically pushed against the coil spring 6 slidably and elastically comes in contact with the internal surface 26a of the notch 26 of the slider 2. Accordingly, if the slider 2 slides, the position of the steel ball 7 elastically coming in contact with the internal surface 26a of the notch 26 is changed and a reaction force applied from the steel ball 7 to the slider 2 is changed.

The switch element 5 is an electrical element that is driven when the slider 2 slides. As shown in FIG. 8, the switch element 5 is mounted on the printed circuit board 8 in the case 4. One of the actuators 50 of the switch element 5 is driven and tilted by the driving protrusion 24 in accordance with the sliding direction of the slider 2. That is, since the pair of actuators 50 and the driving protrusion 24 inserted therebetween are arranged in one line in the sliding direction of the slider 2, for example as shown in FIG. 8, the driving protrusion 24 drives and tilts the actuator 50 that is positioned on the side where the driving protrusion is to slide when sliding. When the actuator 50 is tilted as described above, movable and stationary contacts (not shown) come in contact with each other in the switch element 5, so that a predetermined electrical signal is output. Accordingly, it is possible to adjust the position of the vehicle seat.

As described above, in the slide operation type electrical component according to this embodiment, the first and second protruding parts 21 and 22 of the slider 2 can slide along the guide surfaces 33 and 34 of the first and second guideways 31 and 32 of the holding case 3, respectively. Therefore, a smooth sliding operation may be expected. Further, the internal surface 26a of the notch 26 formed at the first protruding part 21 is formed of a cam face with which the steel ball 7 slidably and elastically comes in contact. When the slider 2 is slid, the steel ball 7 is engaged or disengaged with or from the click groove 27 of the notch 26, so that click feeling is generated. In this case, the notch 26 is formed to be relatively large by using the height of the first protruding part 21 that protrudes from the pedestal part 20. However, there is no concern that the notch 26 adversely affects the mechanical strength of the slider 2. That is, since the limitation on the depth or shape of the click groove 27 is less even though the size of the slider 2 or the holding case 3 of the slide operation type electrical component is not particularly increased, it is possible to set desired click feeling.

Further, when the steel ball 7 is disengaged from the click groove 27, the coil spring 6 is compressed and largely deformed. Therefore, a large load is applied to the first protruding part 21. In this case, the first protruding part 21 of the slide operation type electrical component according to this embodiment is formed to be thick in order to function as a guide. Accordingly, even though a large load is applied to the first protruding part 21 from the steel ball 7 as described above, the first protruding part is hardly deformed. In addition, since the click groove 27 is formed using a guide, it is possible to easily form the click groove 27. Further, the slider 2 is inserted into the guide grooves (both guideways 31 and 32) of the holding case 3 when being assembled, but the coil spring 6 is deformed in the direction of a load in this case. Accordingly, it is possible to easily assemble the slider 2 with the holding case 3.

In addition, in the slide operation type electrical component, the shape of the notch 26 is tapered toward the inside from the opened end, and the click groove 27 is formed at the innermost portion of the notch 26. Accordingly, it is possible to separate the slider 2 from a non-operational position with clear click feeling when the slider slides, and to make the slid slider 2 automatically return to the non-operational position, so that the slider can be stably held at the non-operational position. For this reason, it is possible to obtain a slide operation type electrical component that is excellent in operational feeling or operability.

Further, in the slide operation type electrical component, the protruding end surfaces (bottoms) of both the first and second protruding parts 21 and 22 of the slider 2 are not in contact with the holding case 3. Accordingly, it is easy to make an operator feel click feeling that is generated when the steel ball 7 elastically pushed against the coil spring 6 is engaged or disengaged with or from the click groove 27. Furthermore, in the slide operation type electrical component, the first guideway 31 of the holding case 3 has been formed in the shape of a hole. However, since the spring receiving portion 35 in which the coil spring 6 is received is connected to the guide surface 33, the first guideway 31 is reinforced by the spring receiving portion 35. Accordingly, mechanical strength is increased. And the accuracy of a relative position of the steel ball 7 and the the internal surface 26a of the notch 26 is improved, it is easy that the steel ball 7 slides the internal surface 26a. Therefore,it is easy to improve operability.

The slide operation type electrical component used as a vehicle power seat switch has been described in the above-mentioned embodiment, but the invention is not limited thereto. For example, the same effect as the above-mentioned embodiment may be expected even in the case of a slide operation type electrical component where elastic pushing means such as a steel ball is selectively engaged or disengaged with or from notches that are formed at a plurality of positions of a protruding part of a slider. Further, in the above-mentioned embodiment, the switch element 5 has been driven by the slide of the slider 2, so that a contact switching operation has been performed. However, the slider 2 may be formed to drive other electrical elements such as a variable resistor.

It should be understood by those skilled in the art that various modifications, combinations, sub-combinations and alterations may occur depending on design requirements and other factors insofar as they are within the scope of the appended claims of the equivalents thereof.

What is claimed is:

1. A slide operation type electrical component that includes a slider that includes protruding parts extending in predetermined directions, a holding case that includes guide surfaces slidable on the protruding parts and holds the slider so as to allow the slider to be slidable, and an electrical element that is engaged with the slider and driven when sliding, the slide operation type electrical component comprising:
a notch that is opened at a protruding end surface of a part of the protruding parts;
guideways that are formed at the holding case in the shape of a hole or groove extending in the sliding direction of the slider so that side walls of the guideways form the guide surfaces; and
an elastic pushing means that is disposed at a part of the guideways so as to elastically come in contact with an internal surface of the notch.

2. The slide operation type electrical component according to claim 1,
wherein the shape of the notch is tapered toward the inside from an opened end, and
a click groove is formed at the innermost portion of the notch.

3. The slide operation type electrical component according to claim 1,
wherein the protruding end surface of the protruding part where the notch is formed is not in contact with the holding case.

4. The slide operation type electrical component according to claim 3, further comprising:
a spring receiving portion that faces the guideways and is formed at the holding case so as to be connected to the guide surfaces,
wherein the elastic pushing means includes a coil spring that is held in the spring receiving portion, and a drive body that is disposed in the guideway and elastically comes in contact with the internal surface of the notch by a pushing force of the coil spring.
